(19) United States
(12) Patent Application Publication
(10) Pub. No.: US 2019/0139432 A1
(43) Pub. Date: May 9, 2019

(54) METHODS AND SYSTEMS FOR ANIMATED WALKTHROUGHS IN AN ONLINE EDUCATIONAL PLATFORM

(71) Applicants: Kalpit Jain, San Jose, CA (US); Neil Reddy Chintala, Milipitas, CA (US); Zhi Feng Huang, San jose, CA (US); Kaushal Mehta, Fremont, CA (US); Alok Nandan, Santa clara, CA (US)

(72) Inventors: Kalpit Jain, San Jose, CA (US); Neil Reddy Chintala, Milipitas, CA (US); Zhi Feng Huang, San jose, CA (US); Kaushal Mehta, Fremont, CA (US); Alok Nandan, Santa clara, CA (US)

(21) Appl. No.: 15/992,148

(22) Filed: May 29, 2018

Related U.S. Application Data
(60) Provisional application No. 62/512,178, filed on May 29, 2017.

(51) Int. Cl. G09B 7/00; G06T 13/80; G06F 16/14

(52) U.S. Cl. CPC G09B 7/00; G06F 16/148; G06T 13/80

(57) ABSTRACT

A computerized method useful for generating an animated GIF related to an educational content based on a learning context in an online educational platform including the step of obtaining a digital image. The method includes the step of receiving a set of administrator edits to the digital image. The method includes the step of generating animated Graphics Interchange Format (GIF) image. The GIF image comprises the digital image and the set of user edits to said digital image. The method includes the step of generating a digital tutorial to a learning user with respect to an online educational. The method includes the step of including the animated GIF file within a flow of the digital tutorial.

### CLAIM OF PRIORITY

This application claims priority from U.S. Provisional Application No. 62/512,178, METHODS AND SYSTEMS FOR ANIMATED WALKTHROUGHS IN AN ONLINE EDUCATIONAL PLATFORM and filed 29 May 2017. This application is hereby incorporated by reference in its entirety for all purposes.

### BACKGROUND

How individuals discover and learn about content, products and services continues to evolve. Intelligent search has grown significantly in recent years. Services are now able to leverage intelligent search that combines context and intent to help individuals discover digital knowledge. For example, a search for ‘doctors’ or ‘insurance’ can return a map and additional location information for nearby insurance agents, their hours and their rating.

Furthermore, organizations may lack a way to identify experts in an organization based on user feedback. The organization may want to learn who can best teach data science in an organization or who is the most recognized expert in a specific skill can be found by doing a user survey.

### BRIEF SUMMARY OF THE INVENTION

A computerized method useful for generating an animated GIF related to an educational content based on a learning context in an online educational platform including the step of obtaining a digital image. The method includes the step of receiving a set of administrator edits to the digital image. The method includes the step of generating animated Graphics Interchange Format (GIF) image. The GIF image comprises the digital image and the set of user edits to said digital image. The method includes the step of generating a digital tutorial to a learning user with respect to an online educational. The method includes the step of including the animated GIF file within a flow of the digital tutorial.

### BRIEF DESCRIPTION OF THE DRAWINGS

FIG. 1 illustrates an example system for generating and providing animated GIFs, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 provides an example process for generating an animated GIF, according to some embodiments.

FIG. 5 illustrates an example process for answering a customer's query to a chatbot with an animated GIF, according to some embodiments

FIGS. 6-13 illustrate an example series of screen shots of an animated GIF sequence, according to some embodiments.

The Figures described above are a representative set, and are not an exhaustive with respect to embodying the invention.

### DESCRIPTION

Disclosed are a system, method, and article of animated walkthroughs in an online educational platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Graphics Interchange Format (GIF) a lossless format for image files that supports both animated and static images.

### Exemplary Systems

An animated GIF (Graphics Interchange Format) file is a graphic image that moves. Examples of animated GIFs include, for example, a twirling icon; a banner with a hand that waves or letters that magically get larger. An animated GIF can be a file in the Graphics Interchange Format specified as GIF89a. An animated GIF can contain within a single file a set of images that are presented in a specified order. An animated GIF can loop endlessly (e.g. it appears as though your document never finishes arriving) or it can present one or a few sequences and then stop the animation. An animated GIFs can be used in online advertising space (for display banners and such).

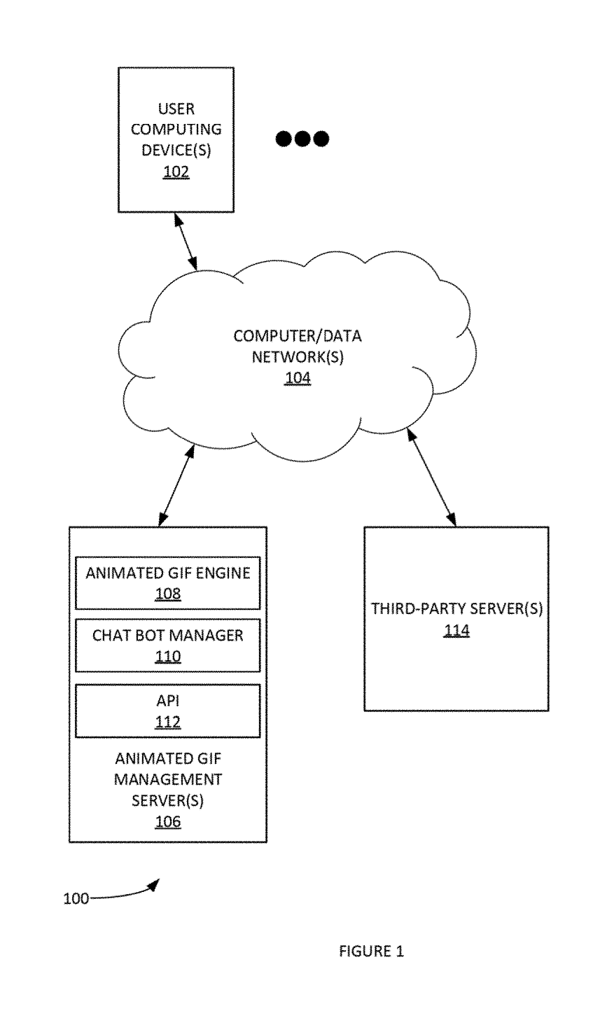

FIG. 1 illustrates an example system 100 for generating and providing animated GIFs, according to some embodiments. System 100 can generate various product walkthroughs as animated GIFs. System 100 can provide these animated GIFs can be provided to a relevant software vendor to assist in software sales. The animated gifs are “inline” (it will “auto-play” in emails, tweets unlike videos). Animated GIFs are mobile friendly (e.g. have a smaller footprint than a video—hence more shareable). Animated GIFs are repetitive and can be used for learning environment (e.g. where people may remember the steps better if they see it multiple times). Animated GIFs have universal web browser support and can be viewed without additional software downloads. These entities can access the services of Animated GIF management server 106 via API 112.

Networks 104 can include the Internet, text messaging networks (e.g. short messaging service (SMS) networks, multimedia messaging service (MMS) networks, proprietary messaging networks, instant messaging service networks, email servers, etc. Networks 104 can be used to communicate messages and/or other information (e.g. videos, tests, articles, other educational materials, etc.) from the various entities of system 100. In one implementation, networks 104 may be a wireless network, a wired network or a combination thereof. Networks 104 can be implemented as one of the different types of networks, such as intranet, local area network (LAN), wide 20 area network (WAN), the internet, and the like. Networks 104 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the networks 104 may include a variety of network devices, including routers, bridges, servers, computing devices, storage devices, and the like.

User-computing devices 102 can be any computing device used by a user to access/consume educational content provided by system 100 (e.g. via online education platform 106). Example user-computing devices can include, inter alia: personal computers, mobile devices, augmented reality devices, virtual reality devices, tablet computers, etc. User-computing devices 102 can access animated GIF management server 106 (e.g. via a website, mobile application, etc.). User-computing devices 102 can enable a user to upload a series of digital images used to generate animated GIF management server 106. User-computing devices 102 can enable a user to communicate already generated animated GIFs to others (e.g. via text message, email, etc.). User-computing devices 102 can enable a user to interact with a chatbot and/or manage a chatbot's settings. For example, a user can manage a chat bot service. The user can provide various animated GIFs for use by the chat bot when interacting with other system users.

Animated GIF management server 106 can manage and provide animated GIF content to user-computing devices 102. For example, animated GIF management server 106 can disseminate software-sales related animated GIFs. Animated GIF management server 106 can receive a set user uploaded digital images and transform this into an animated GIF. Animated GIF management server 106 can provide interfaces for obtaining user information. Animated GIF management server 106 can interact with and/or obtain information from third-party server(s) 110. In one example, third-party server(s) 110 can be an online-educational platform. In another example, third-party server(s) 110 can be a software sales service's platform.

Animated GIF engine 108 can generate animated GIFs. For example, a user can use a graphics editor to generate various aspects of an animated GIFs content. The user can upload various digital images to be included in the animated GIF. An example of a series of screen shots showing an animated GIF sequence is provided infra. Animated GIF engine 108 can provide a web site that provides machine generated in-application animated GIF/Audio walkthroughs. It can play-back contextual walkthroughs via IE, Firefox and Chrome extensions and/or .js file.

Chatbot manager 110 can implement a chat bot program. Chatbot manager 110 can use animated GIFs as answers to user queries to the chatbot program. A chatbot can a computer program which conducts a conversation via auditory or textual methods. Such programs are often designed to convincingly simulate how a human would behave as a conversational partner. Chatbot manager 110 can use a dialog system(s) for various practical purposes including customer service or information acquisition. Chatbot manager 110 can use sophisticated natural language processing systems, but many simpler systems scan for keywords within the input, then pull a reply with the most matching keywords, or the most similar wording pattern, from a database. Chatbot manager 110 can be used to support customer calls and/or ticket results in an email to the customer. Chatbot manager 110 can embed animated GIFs in email. The animated GIF can provide a complete solution to the customer that can help him/her or her solve the support problem. Chatbot manager 110 can interactive guidance in the animated GIF. Chatbot manager 110 can enable chat bots to respond via animated GIFs. Customers interact with chat bots which can be managed by humans and/or artificial intelligence (AI) modules. Chatbot manager 110 can provide a workflow via which a human or a AI module can automatically respond to a customer request with a gif walkthrough. Chatbot manager 110 can enable a self-serve solution of customer workflow problems via animated GIF walkthroughs. Human chat agents can also deliver animated GIF walkthroughs that answer client questions/queries.

Animated GIF management server 106 can include various other functionalities and systems, including, inter alia: email servers, text messaging servers, instant messaging servers, video-sharing servers, mapping and geolocation servers, network security services, language translation functionalities, database management systems, application programming interfaces, etc. Animated GIF management server 106 can include various machine learning functionalities that can analyze user behavior, educational content, user profiles, digital-image editing modules (e.g. raster graphics editors, other graphics editors, etc.), etc.

Animated GIF management server 106 can utilize machine learning techniques (e.g. artificial neural networks, etc.) to perform various analysis functions. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. The analysis can be used to match users with animated GIFs and/or otherwise optimize the user experience.

Although the present subject matter is explained considering that the system 100 is implemented on a server 106, it may be understood that the system 100 may also be implemented in a variety of computing systems, such as a distributed system, a laptop computer, a desktop computer, a notebook, a workstation, a mainframe computer, a server, a network server, and using a variety of database software like—RDBMS (example—Oracle, Postgres), distributed file systems (e.g. MapR, etc.). Examples of the user devices 103 may include, but are not limited to, a portable computer, a personal digital assistant, a handheld device, and a workstation.

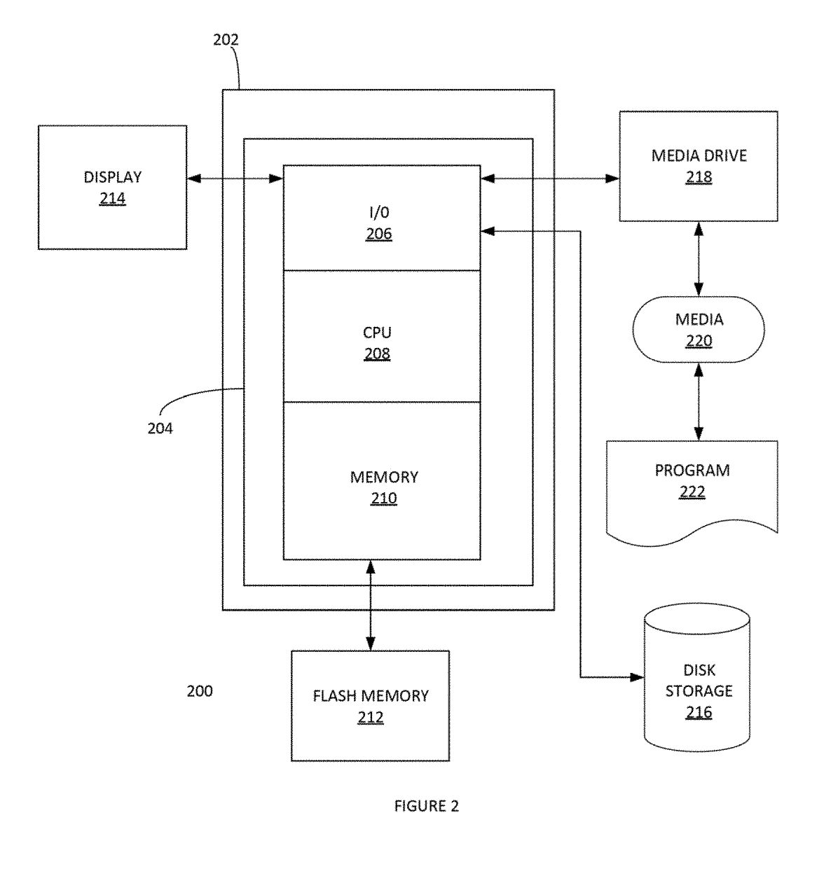

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

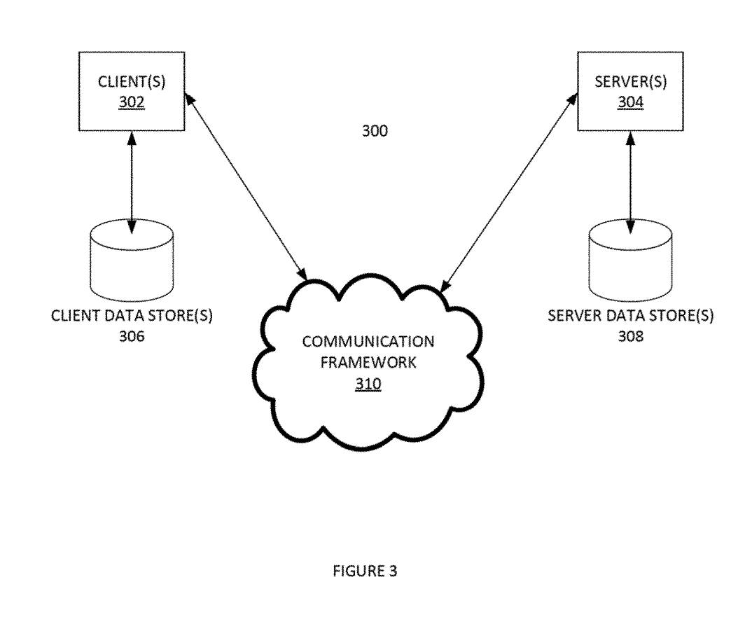

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### Exemplary Methods

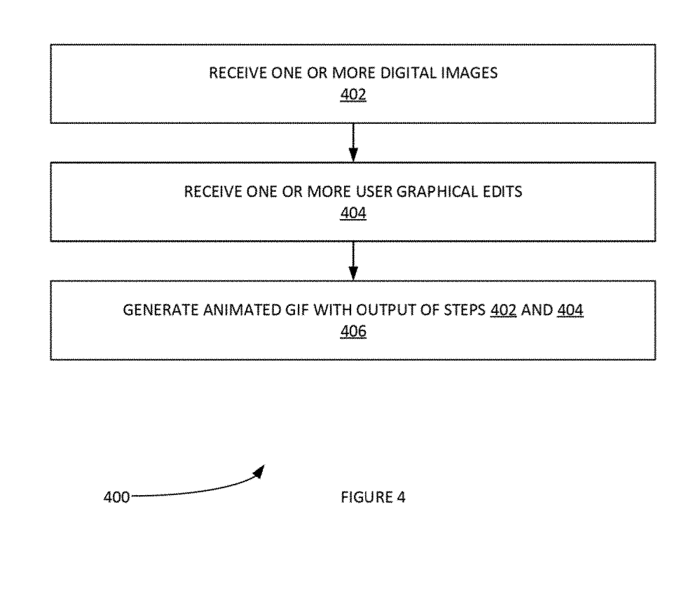

FIG. 4 provides an example process 400 for generating an animated GIF, according to some embodiments. In step 402, process 400 can receive one or more digital images. In step 404, process 400 can receive one or more user edits to the digital image(s). In step 406, process 400 can generate animated GIF with output of steps 402 and 404. The animated GIF can provide a tutorial to a user with respect to a good or service for sale. The animated GIF can provide a tutorial to a user with respect to an online educational content. An online educational content platform can automatically obtain the output of steps 402 and 404 in response to a user query and generate an applicable animated GIF. A retail provider can automatically obtain the output of steps 402 and 404 in response to a user query and generate an applicable animated GIF. The output of process 400 can be provided to process 500 infra in a chatbot context.

In one example embodiment, animated GIF file can comprise a number of frames that are displayed in succession, each introduced by its own Graphics Control Extension (GCE), which gives the time delay to wait after the frame is drawn. Global information at the start of the file applies by default to all frames. The data is stream-oriented, so the file-offset of the start of each GCE depends on the length of preceding data. Within each frame the LZW-coded image data is arranged in sub-blocks of up to two hundred and fifty-five (255) bytes; the size of each sub-block is declared by the byte that precedes it.

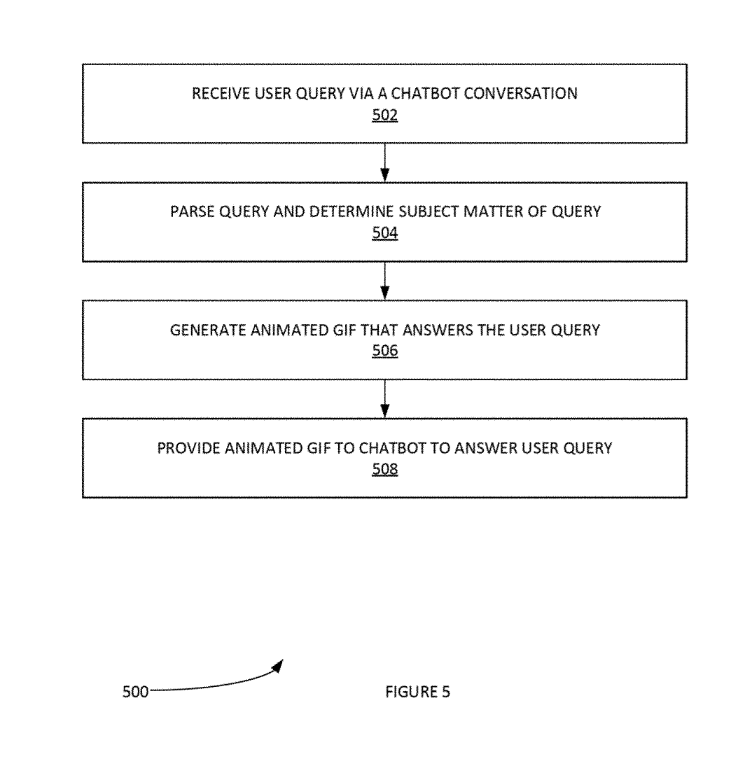

FIG. 5 illustrates an example process 500 for answering a customer's query to a chatbot with an animated GIF, according to some embodiments. In step 502, process 500 can receive user query via a chatbot conversation. In step 504, process 500 can parse query and determine subject matter of query. In step 506, process 500 can generate animated gif that answers the user query. In step 508, process 500 can provide animated gif to chatbot to answer user query.

### Example Screen Shots of an Animated GIF Sequence

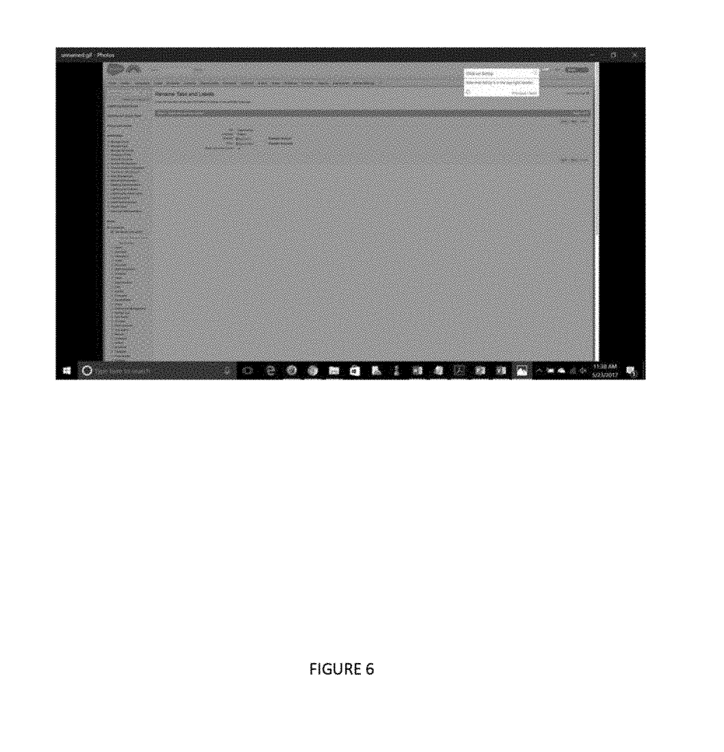

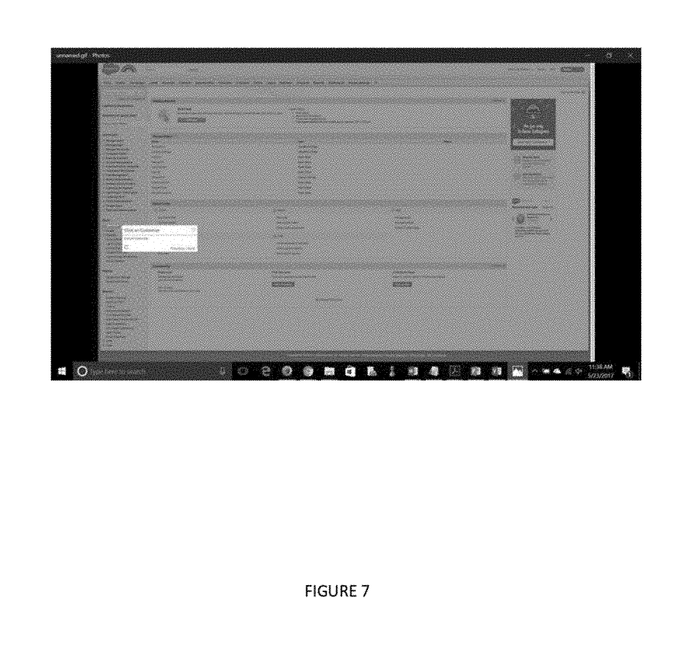

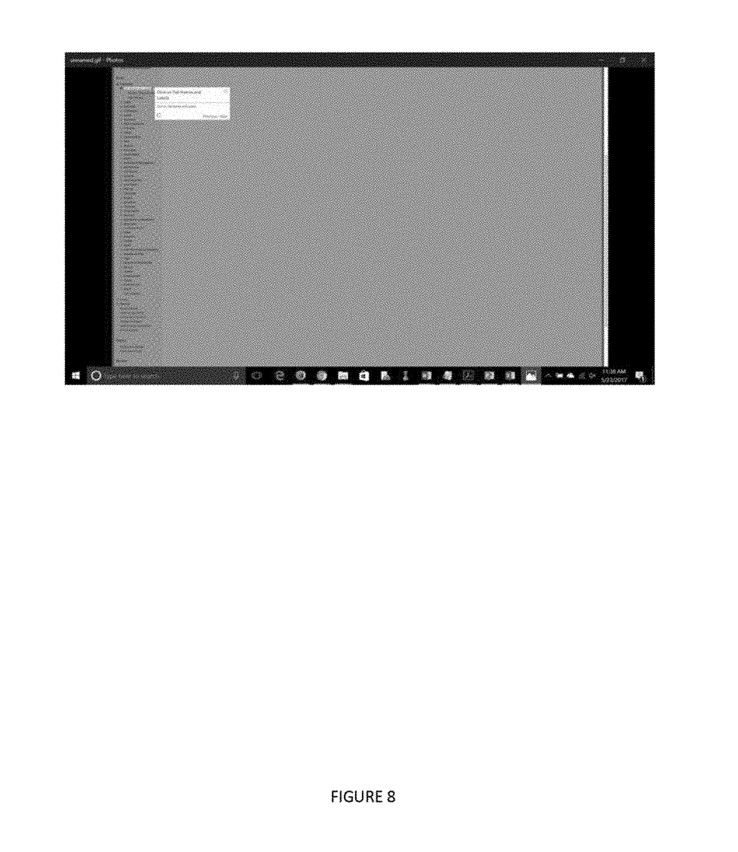

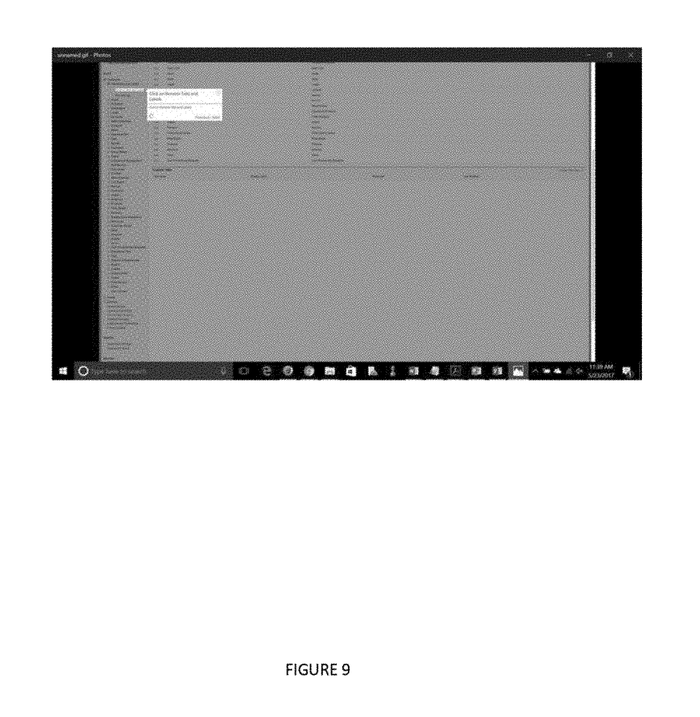

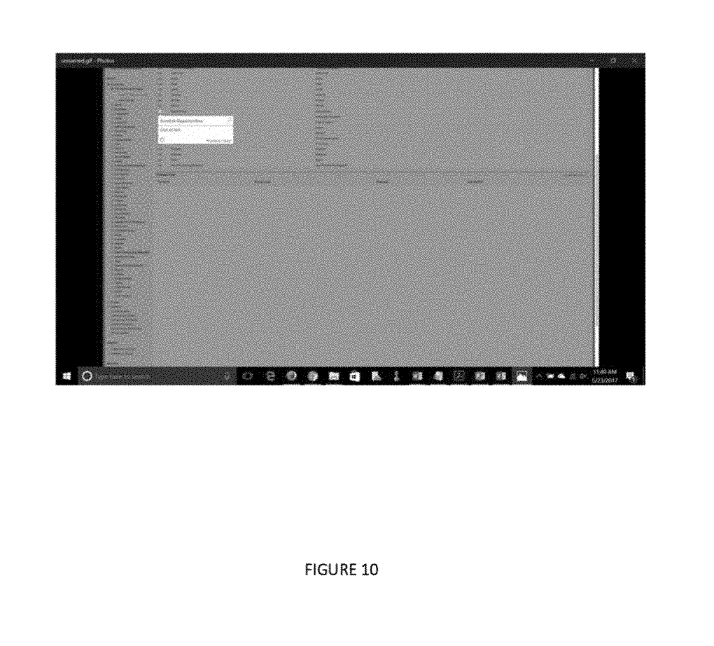

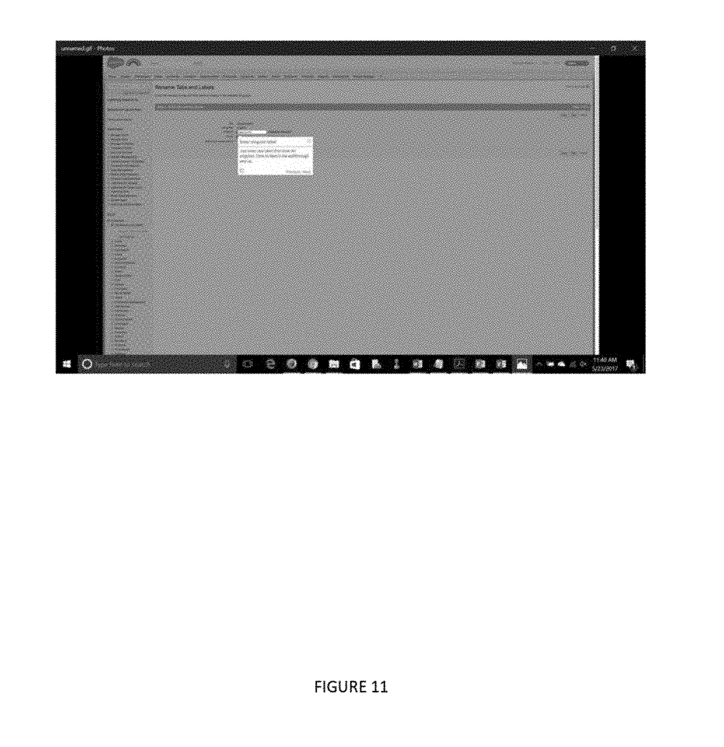

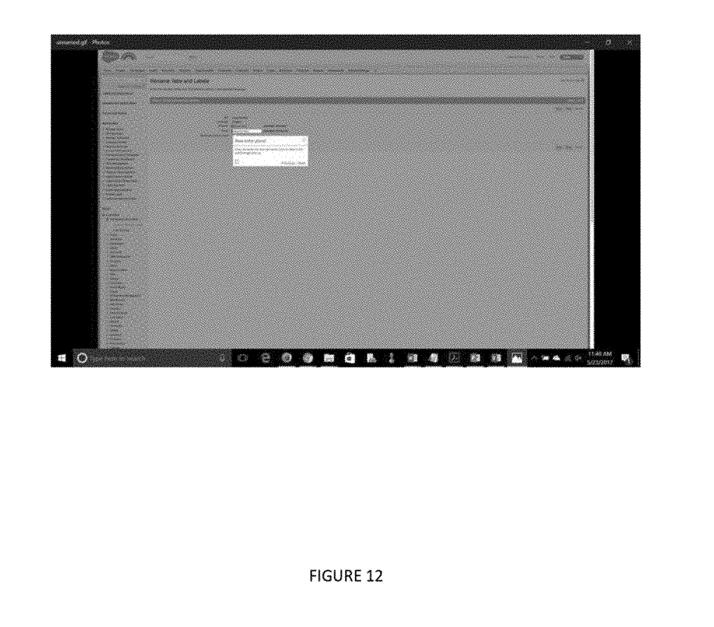

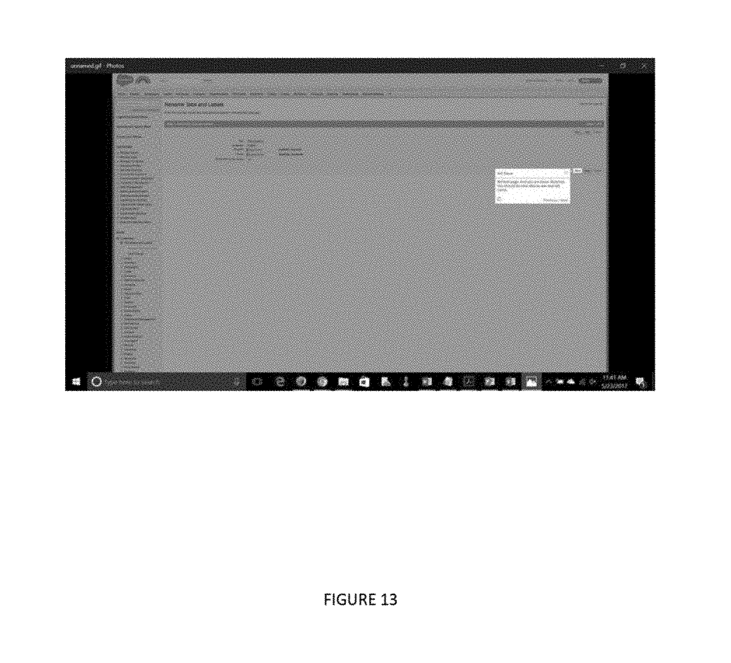

FIGS. 6-13 illustrate an example series of screen shots of an animated GIF sequence, according to some embodiments. The animated GIF can be generated using systems 100-300 and processes 400 and/or 500.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method useful for generating an animated Graphics Interchange Format (GIF) related to an educational content based on a learning context in an online educational platform comprising:
obtaining a digital image;
receiving a set of administrator edits to the digital image;
generating animated GIF image, wherein the GIF image comprises the digital image and the set of user edits to said digital image;
generating a digital tutorial to a learning user with respect to an online educational; and
including the animated GIF file within a flow of the digital tutorial.

2. The method of claim 1 further comprising:
receiving a query from the learning user while the learning user is accessing the digital tutorial.

3. The method of claim 2, wherein a content of the digital image is related to the query from the learning user.

4. The method of claim 3 further comprising:
automatically displaying the animated GIF image with the content related to the query inline with the education content of the digital tutorial.

5. The method of claim 4, wherein the animated GIF image has universal web browser support and is viewable without additional software downloads.

6. A computerized system useful for generating an animated Graphics Interchange Format (GIF) related to an educational content based on a learning context in an online educational platform comprising:
at least one processor configured to execute instructions;
a memory containing instructions when executed on the processor, causes the at least one processor to perform operations that:
obtain a digital image;
receive a set of administrator edits to the digital image;
generate animated GIF image, wherein the GIF image comprises the digital image and the set of user edits to said digital image;
generate a digital tutorial to a learning user with respect to an online educational; and
include the animated GIF file within a flow of the digital tutorial.

7. The system of claim 6 further comprising:
receiving a query from the learning user while the learning user is accessing the digital tutorial.

8. The system of claim 7, wherein a content of the digital image is related to the query from the learning user.

9. The system of claim 8 further comprising:
automatically displaying the animated GIF image with the content related to the query in-line with the education content of the digital tutorial.

10. The system of claim 9, wherein the animated GIF image has universal web browser support and is viewable without additional software downloads.

11. A computerized method useful for answering a customer's query to a chatbot with an animated Graphics Interchange Format (GIF) in an online educational platform comprising:
receiving user query via a chatbot conversation;
parsing query and determine subject matter of query;
automatically generating animated gif that answers the user query;
provide animated GIF to chatbot to answer the user query.
